(19) United States
(12) Patent Application Publication
(10) Pub. No.: US 2022/0305933 A1
(43) Pub. Date: Sep. 29, 2022

(54) POWER SUPPLYING FACILITY FOR ELECTRIC VEHICLE AND POWER SUPPLY METHOD FOR ELECTRIC VEHICLE USING POWER SUPPLYING FACILITY

(71) Applicant: IHI Corporation, Tokyo (JP)

(72) Inventor: Motonao NIIZUMA, Tokyo (JP)

(73) Assignee: IHI Corporation, Tokyo (JP)

(21) Appl. No.: 17/698,297

(22) Filed: Mar. 18, 2022

(30) Foreign Application Priority Data
Mar. 26, 2021 (JP) 2021-053796

(51) Int. Cl. B60L 53/36; B60L 53/302; B60L 53/12; B60L 53/67; E05F 15/73; E04H 6/08; E04H 6/42; F24F 11/63

(52) U.S. Cl. CPC B60L 53/36; B60L 53/302; B60L 53/12; B60L 53/67; E05F 15/73; E04H 6/08; E04H 6/424; F24F 11/63; E05Y 2400/45; E05Y 2900/106

(57) ABSTRACT

A power supplying facility includes: a power supply device installed in a building that has a power supply space for supplying power to an electric vehicle having a battery, and supplying power wirelessly to the battery of the electric vehicle parked in the power supply space by means of an automatic parking function, and a building air conditioner communicatively connected to the power supply device, and conditioning air inside of the building based on an operating state of the power supply device.

### CROSS REFERENCE TO RELATED APPLICATIONS

This application is based on, and claims priority from Japanese Patent Application No. 2021-053796 filed on Mar. 26, 2021, and the entire contents of this application is incorporated herein by reference.

### BACKGROUND

### 1. Technical Field

The present disclosure relates to a power supplying facility for an electric vehicle and a power supply method for an electric vehicle using the power supplying facility.

### 2. Description of the Related Art

When a user gets into an electric vehicle equipped with a battery and starts driving, it is desirable that not only the battery is charged but also the inside of the vehicle is air-conditioned to a temperature comfortable for the user. Therefore, by operating an on-vehicle air conditioner while charging the battery, the temperature inside the vehicle becomes appropriate when charging is completed, and the user can immediately get in and start driving comfortably (see Japanese Patent Application Publication No. H7-193901).

However, the battery of an electric vehicle is used as a power source for both the running of the electric vehicle and the driving of an on-vehicle air conditioner for air-conditioning the inside of the electric vehicle. Therefore, if the on-vehicle air conditioner is operated while the battery is being charged, some of the electric power is consumed by the on-vehicle air conditioner and the electric power used for charging the battery decreases, and it takes a longer time to charge the battery compared to a case where the on-vehicle air conditioner is not operated.

### SUMMARY

Further, regarding the use of electric vehicles, the car sharing form of usage in which an unspecified number of users share a plurality of electric vehicles for a fixed time is increasing. Electric vehicles used in car sharing are more frequently used than privately owned electric vehicles and are often used in short time cycles, so the electric vehicles are more likely to be used by users immediately after the battery has been charged. Therefore, for a plurality of electric vehicles used in this way, it is desirable to perform power supply and air conditioning in vehicles simultaneously and unmanned, and to automatically prepare an electric vehicle ready for users to get in and to use as soon as possible after the battery is fully charged and the temperature inside the vehicle is appropriate for users to stay inside the vehicle comfortably. Thus, it is desirable to increase the availability of electric vehicles.

The present disclosure has been made in consideration of the above-mentioned situation. An object of the present disclosure is to provide a power supplying facility for an electric vehicle and a power supply method for an electric vehicle using the power supplying facility, which are capable of increasing the availability of electric vehicles by performing unmanned power supply to electric vehicles while adjusting the temperature inside the electric vehicles.

A power supplying facility for an electric vehicle, according to one aspect of the present disclosure, includes: a power supply device installed in a building that has a power supply space for supplying power to the electric vehicle having a battery, and supplying power wirelessly to the battery of the electric vehicle parked in the power supply space by means of an automatic parking function, and a building air conditioner communicatively connected to the power supply device, and conditioning air inside of the building based on an operating state of the power supply device.

When the electric vehicle is parked in the power supply space and supplied with electric power by the power supply device, the building air conditioner may start conditioning air at a time that is a predetermined time period before a scheduled exit time at which the power supply device stops supplying electric power and the electric vehicle exits from the building.

The electric vehicle may be provided with a sensor configured to detect a person in the electric vehicle, and when electric power is supplied to the electric vehicle, upon it being determined that inside of the electric vehicle is unmanned based on a detection result obtained by the sensor, the electric vehicle may be parked in the power supply space by means of the automatic parking function.

The building may be further provided with a marker installed in the power supply space, the electric vehicle may be provided with a marker recognition device for recognizing the marker, and when electric power is supplied to the electric vehicle, the marker recognition device may recognize a position of the marker, and the electric vehicle may be parked in the power supply space by means of the automatic parking function based on the position of the marker.

The building may further include an opening having a size capable of allowing the electric vehicle to pass through, and an automatic opening/closing door configured to automatically open/close the opening, which opens the opening if the power supply space is vacant when a request to enter the building is received from the electric vehicle by wireless communication, and closes the opening when it is detected that the electric vehicle has entered the building and parked in the power supply space, and when electric power is supplied to the electric vehicle, the electric vehicle may transmit an entry request for entering the building by wireless communication, and enter the building from the opening opened by transmission of the entry request and park in the power supply space by means of the automatic parking function.

The power supplying facility may include a plurality of buildings in which the power supply space, the power supply device, and the building air conditioner are installed, and a general control device, wherein when electric power is supplied to the electric vehicle, the electric vehicle transmits an entry request for entering one of the plurality of buildings, and enters the power supply space selected by transmission of the entry request and parks in the selected power supply space by means of the automatic parking function, and the general control device selects a vacant power supply space as a power supply space to be entered by the electric vehicle upon receiving the entry request from the electric vehicle.

Each of the buildings may include an opening having a size capable of allowing the electric vehicle to pass through, and an automatic opening/closing door configured to automatically open/close the opening, which opens the opening when the power supply space corresponding to the opening is selected by the general controller as a space to be entered by the electric vehicle, and closes the opening when it is detected that the electric vehicle has entered the building and parked in the power supply space, and when electric power is supplied to the electric vehicle, the electric vehicle may transmit the entry request, and enter the building from the opening opened by transmission of the entry request and park in the power supply space by means of the automatic parking function.

A power supplying facility for an electric vehicle, according to another aspect of the present disclosure, includes: a plurality of power supply devices provided in a plurality of power supply spaces, respectively, in which electric vehicles are to park in line one behind another from a head side to a tail side of the plurality of power supply spaces, and each supplying power wirelessly to a battery of an electric vehicle parked in a corresponding power supply space of the plurality of power supply spaces by means of an automatic parking function, and a general control device controlling parking of two or more of the electric vehicles in line one behind another from a power supply space on the head side of the plurality of power supply spaces, moving of one electric vehicle parked in the power supply space on the head side out of the power supply space after stopping power supply to the one electric vehicle parked in the power supply space on the head side, and moving of another electric vehicle positioned behind the one electric vehicle to the power supply space on the head side, wherein the power supply space on the head side is installed in a building, a building air conditioner is installed in the building, and the building air conditioner is communicatively connected to the power supply device installed in the power supply space on the head side, and configured to condition air inside of the building based on an operating state of the power supply device installed in the power supply space on the head side.

The electric vehicle may be provided with at least one of a window or a ventilation port, each of which is configured to be opened and closed automatically, the at least one of the window or the ventilation port may be opened when the building air conditioner starts conditioning air, and the at least one of the window or the ventilation port may be closed when the building air conditioner stops conditioning air.

A power supplying method for an electric vehicle using a power supplying facility, according to another aspect of the present disclosure, wherein the power supplying facility is configured by installing a power supply device in a building having a power supply space for supplying power to the electric vehicle having a battery, and communicatively connecting a building air conditioner to the power supply device, the power supplying method including supplying power wirelessly by means of the power supply device to the battery of the electric vehicle parked in the power supply space by means of an automatic parking function, and conditioning air inside of the building by means of the building air conditioner based on an operating state of the power supply device.

According to the present disclosure, it is possible to increase the availability of electric vehicles by performing unmanned power supply to electric vehicles while adjusting the temperature inside the electric vehicles.

### BRIEF DESCRIPTION OF THE DRAWINGS

FIG. 1A is a schematic view showing a power supplying facility according to a first embodiment and an electric vehicle using the power supplying facility as viewed from the side (the side of the power supplying facility is not shown).

FIG. 1B is a schematic view showing the inside of the power supplying facility according to the first embodiment as viewed from the above.

FIG. 2 is a block diagram showing a configuration of the power supplying facility according to the first embodiment.

FIG. 3 is a block diagram showing an electric vehicle using the power supplying facility according to the first embodiment and a second embodiment.

FIG. 4 is a view showing the power supplying facility, a boarding area, and an alighting area, as viewed from the above, according to the first embodiment.

FIG. 5A is a flowchart showing a procedure executed in the power supplying facility and the electric vehicle when electric power is supplied to the electric vehicle by the power supplying facility according to the first embodiment.

FIG. 5B is a flowchart showing a procedure executed in the power supplying facility and the electric vehicle when electric power is supplied to the electric vehicle by the power supplying facility according to the first embodiment.

FIG. 6 is a whole figure showing a configuration of the power supplying facility according to the second embodiment.

FIG. 7 is a view showing the power supplying facility, a boarding area, and an alighting area, according to the second embodiment.

FIG. 8A is a flowchart showing a procedure executed in the power supplying facility, a general control device, and the electric vehicle, when electric power is supplied to the electric vehicle by the power supplying facility according to the second embodiment.

FIG. 8B is a flowchart showing a procedure executed in the power supplying facility, the general control device, and the electric vehicle, when electric power is supplied to the electric vehicle by the power supplying facility according to the second embodiment.

FIG. 9 is a view showing the power supplying facility, the boarding area, and the alighting area, according to another embodiment.

FIG. 10 is a flowchart showing an opening/closing operation of windows and a ventilation port of the electric vehicle, executed in the power supplying facility and the electric vehicle, when electric power is supplied to the electric vehicle by the power supplying facility according to the first embodiment or the second embodiment.

### DESCRIPTION OF THE EMBODIMENTS

Hereinafter, some exemplary embodiments of a power supplying facility of an electric vehicle (electric car) will be described with reference to the drawings. The power supplying facilities described in the following embodiments are facilities that wirelessly supply electric power to the battery of an electric vehicle.

### First Embodiment

<Configuration of Power Supplying Facility According to First Embodiment>

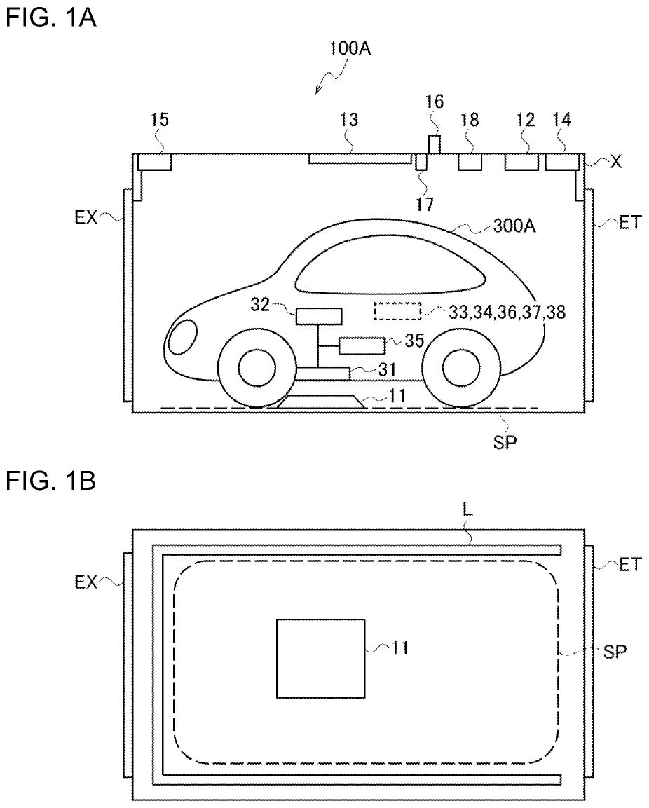

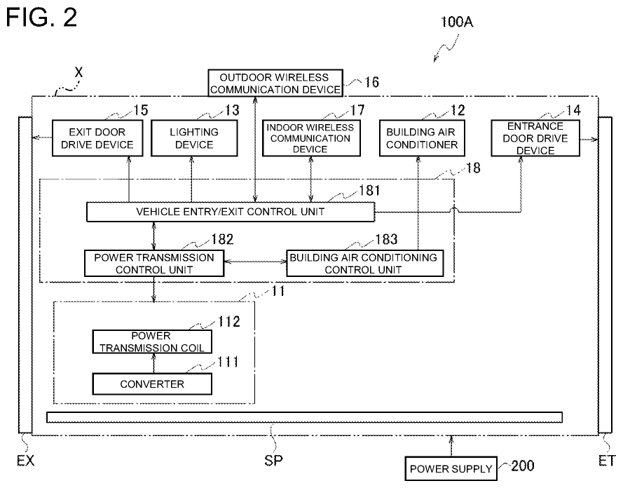

The configuration of a power supplying facility for an electric vehicle according to the present embodiment will be described with reference to FIGS. 1A, 1B, and 2. FIG. 1A is a schematic view showing a power supplying facility 100A according to the present embodiment and an electric vehicle 300A using the power supplying facility 100A as viewed from the side (the side of the power supplying facility 100A is not shown). FIG. 1B is a schematic view showing the inside of the power supplying facility 100A according to the present embodiment as viewed from the above. FIG. 2 is a block diagram showing a configuration of the power supplying facility 100A according to the present embodiment.

As shown in FIGS. 1A and 1B, the power supplying facility 100A is provided in a building X having a size (width, length, height) capable of accommodating the electric vehicle 300A to be supplied with electric power. This building X may be installed outdoors, in a large warehouse, or in a space with a roof but no walls, such as in a large self-driving type of parking space with multiple floors. In this building X, a power supply space SP for the electric vehicle 300A to park and to be supplied with electric power is provided. On the floor surface, corresponding to the power supply space SP, a white line L is provided as a marker to be aimed for as a parking position by the electric vehicle 300A to be supplied with electric power.

Further, an opening (not shown) having a size through which the electric vehicle 300A can pass is formed at an entrance of the building X, and an entrance door ET which is an automatic opening-closing door for opening/closing the opening is provided. Further, an opening (not shown) having a size through which the electric vehicle 300A can pass is formed at an exit of the building X, and an exit door EX which is an automatic opening-closing door for opening/closing the opening is provided. The entrance door ET and exit door EX are configured to be able to be opened and closed unmanned and automatically by means of electric power or power such as pneumatic pressure or hydraulic pressure. In addition, the walls and ceiling of the building X have high heat insulation properties with, for example, glass wool being attached to all surfaces of the walls and ceiling. When the entrance door ET and the exit door EX are closed, the amount of air entering and exiting between the space inside the building X and the outside space is reduced. Thus, the building X has a space that is closed and has heat insulating properties, and the internal temperature of the space can be controlled by the building air conditioner described later. As will be described later, the electric vehicle 300A moves by means of an automatic parking function, and no user gets on and off the electric vehicle 300A in the building X. Therefore, it is sufficient if there is an adequate gap to allow movement for automatic parking between the electric vehicle 300A and the building X when the electric vehicle 300A is parked. Here, an “adequate gap” is a gap that does not cause the outer surface of the electric vehicle 300A and the inner surface of the building X to collide or rub against each other while the electric vehicle 300A is moving for automatic parking. Furthermore, in the gap, there is no need for space for a person to enter and there is no need for space for opening a door of the electric vehicle 300A. One or both of the entrance door ET and the exit door EX may be implemented in another form as long as they can be automatically opened and closed unmanned. For example, one or both of the entrance door ET and the exit door EX may be shutters that move up and down electrically.

The building X is provided with a power supply device 11, a building air conditioner 12, a lighting device 13, an entrance door drive device 14, an exit door drive device 15, an outdoor wireless communication device 16, an indoor wireless communication device 17, and a power supply controller 18, as devices constituting the power supplying facility 100A. These devices 11 to 18 operate on a power supply 200. The power supply 200 may be, for example, a commercial power source supplied from a power plant, or a solar or wind power source, or a fuel cell. These devices 11 to 18 will be described with reference to FIG. 2.

The power supply device 11 is a power transmission device installed in the power supply space SP and includes a converter 111 and a power transmission coil 112. The converter 111 converts the electric power supplied from the power supply 200 into AC (alternating current) power of a high frequency (for example, frequency 100 kHz). The power transmission coil 112 is magnetically coupled to the power reception coil of a power receiving device mounted on the electric vehicle 300A to be supplied with power, and the power transmission coil 112 wirelessly supplies the converted AC power. The power transmission coil 112 is installed on the floor surface of the building X, at a position several centimeters higher than the floor surface, or at a position embedded below the floor surface. A magnetic resonance method, an electric field method, or the like can be used as the wireless power supply method executed by the power supply device 11. In the case of the electric field method, the power transmission coil and the power reception coil are coupled by an electric field. The wireless power supply method is not limited to the above-mentioned examples as long as the method can supply electric power to the battery of the electric vehicle 300A.

The building air conditioner 12 is installed on the wall of a side surface or the ceiling of the building X, and the building air conditioner 12 conditions air inside of the building X based on the operating state of the power supply device 11. The lighting device 13 illuminates the inside of the building X. The entrance door drive device 14 drives the opening/closing operation of the entrance door ET. The exit door drive device 15 drives the opening/closing operation of the exit door EX.

The outdoor wireless communication device 16 is installed outside the building X, and performs wireless communication with the electric vehicle 300A positioned outside the building X. The outdoor wireless communication device 16 may abut the exterior surface of the building X, or may be supported by, for example, a column away from the exterior surface of building X. The indoor wireless communication device 17 is installed in the building X and performs wireless communication with the electric vehicle 300A positioned in the building X. In the present embodiment, the case where two wireless communication devices (the outdoor wireless communication device 16 and the indoor wireless communication device 17) are installed at the building X has been described; however, the number of wireless communication devices is not limited to this, and one wireless communication device which can communicate both indoors and outdoors may be installed at the building X. Further, when the size of the building X is large, three or more wireless communication devices may be installed so that an area through which the electric vehicle 300A passes other than the power supply space SP in the building X is also regarded as a wireless communication target area.

The power supply controller 18 includes a vehicle entry/exit control unit 181, a power transmission control unit 182, and a building air conditioning control unit 183. The vehicle entry/exit control unit 181 makes the entrance door ET open by means of the entrance door drive device 14 and turns on the lighting device 13 when the electric vehicle 300A to be supplied with power enters the building X, and makes the entrance door ET close and turns off the lighting device 13 after the electric vehicle 300A enters the building X. When the electric vehicle 300A exits from the building X, the vehicle entry/exit control unit 181 makes the exit door EX open by means of the exit door drive device 15, and makes the exit door EX close after the electric vehicle 300A exits from the building X.

When the electric vehicle 300A to be supplied with power enters and parks in the power supply space SP, the power transmission control unit 182 makes the power supply device 11 execute electric power transmission to the electric vehicle 300A. The building air conditioning control unit 183 makes the building air conditioner 12 execute air conditioning at a prescribed timing during power supply of the electric vehicle 300A.

<Configuration of Electric Vehicle Using Power Supplying Facility 100A>

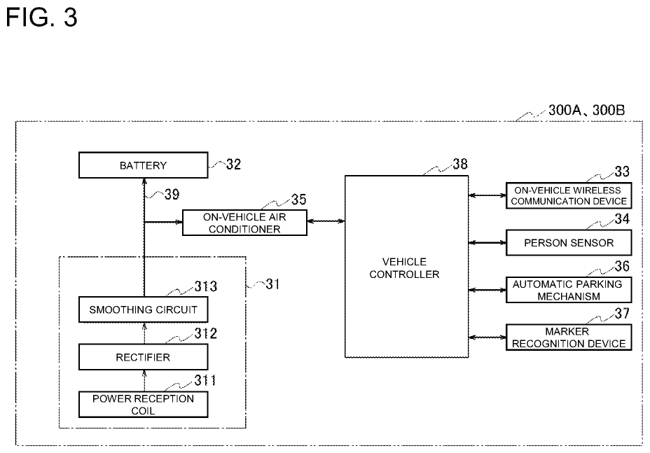

The configuration of the electric vehicle 300A using the power supplying facility 100A will be described with reference to the block diagram of FIG. 3. The electric vehicle 300A includes a power receiving device 31, a battery 32, an on-vehicle wireless communication device 33, a person sensor 34, an on-vehicle air conditioner 35, an automatic parking mechanism 36, a marker recognition device 37, and a vehicle controller 38. The battery 32, the power receiving device 31 and the on-vehicle air conditioner 35 are connected via a power bus 39. The vehicle controller 38, the on-vehicle wireless communication device 33, the person sensor 34, the on-vehicle air conditioner 35, the automatic parking mechanism 36, and the marker recognition device 37 are each communicatively connected via communication lines or wireless communication. Communication lines may be provided independently for each communication connection, or all devices may be connected by a common communication cable, such as in a wired LAN (local area network), and a communication target may be identified by the communication protocol.

The power receiving device 31 includes a power reception coil 311, a rectifier 312, and a smoothing circuit 313. The power reception coil 311 is provided on the lower surface of the electric vehicle 300A, magnetically coupled to the power transmission coil 112 of the power supply device 11, and receives wireless power supply. The rectifier 312 rectifies electric power received by the power reception coil 311. The smoothing circuit 313 is composed of a capacitor and an inductor, smooths the electric power rectified by the rectifier 312, and outputs DC (direct current) power.

The battery 32 is charged with the DC power output from the power receiving device 31. The battery 32 discharges the charged electric power to supply electric power to the on-vehicle air conditioner 35 in the electric vehicle 300A via the power bus 39. When the output voltage of the power receiving device 31 and the voltage of the battery 32 are different, the voltage may be converted by a DC-DC converter (not shown). Power supply to the on-vehicle wireless communication device 33, the person sensor 34, the automatic parking mechanism 36, the marker recognition device 37, and the vehicle controller 38 is not shown, but may be performed, for example, directly from the battery 32 or another battery (for example, a lead storage battery as a starter battery) or through a DC-DC converter for converting voltage.

The on-vehicle wireless communication device 33 performs wireless communication with the outdoor wireless communication device 16 and the indoor wireless communication device 17 of the power supplying facility 100A. The person sensor 34 detects a person in the interior of the electric vehicle 300A by using ultrasonic waves or lasers. The on-vehicle air conditioner 35 conditions air inside of the electric vehicle 300A. The automatic parking mechanism 36 has a function of driving the electric vehicle 300A unmanned and automatically parking the electric vehicle 300A. The marker recognition device 37 recognizes the position of the marker in the building X as a target for the parking position of the electric vehicle 300A to be supplied with power. In the present embodiment, the marker is a white line L provided to the floor surface of the building X, and the marker recognition device 37 has a function of recognizing the position of the white line L by capturing an image of an area including the white line L from a position outside the power supply space SP and analyzing information of the image.

The vehicle controller 38 controls the on-vehicle wireless communication device 33, the person sensor 34, the on-vehicle air conditioner 35, the automatic parking mechanism 36, and the marker recognition device 37. When controlling these devices 33 to 37, the vehicle controller 38 may transmit a control command with an electric signal ON/OFF by wire communication or may transmit a control command by wire communication or wireless communication.

<Operation when Electric Power is Supplied to Electric Vehicle 300A by Power Supplying Facility 100A in First Embodiment>

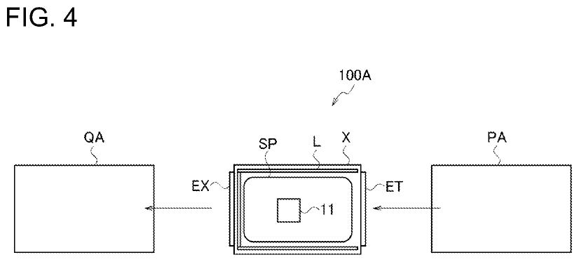

When electric power is to be supplied to the electric vehicle 300A by the power supplying facility 100A according to the present embodiment, the electric vehicle 300A stops in an alighting area PA in front of the entrance of the building X shown in FIG. 4, and all passengers get off the electric vehicle 300A and the door of the vehicle body is closed. Then, the user performs a power supply execution operation. When the power supply execution operation is performed, a series of operations described below is started, and electric power is supplied to the electric vehicle 300A by the power supplying facility 100A. The user performs only the power supply execution operation, and the series of operations after the power supply execution operation are automatically executed without requiring a user operation. The power supply execution operation is realized, for example, by a user pressing a button on a wireless terminal such as a smartphone and sending a command to the vehicle controller 38 via the on-vehicle wireless communication device 33.

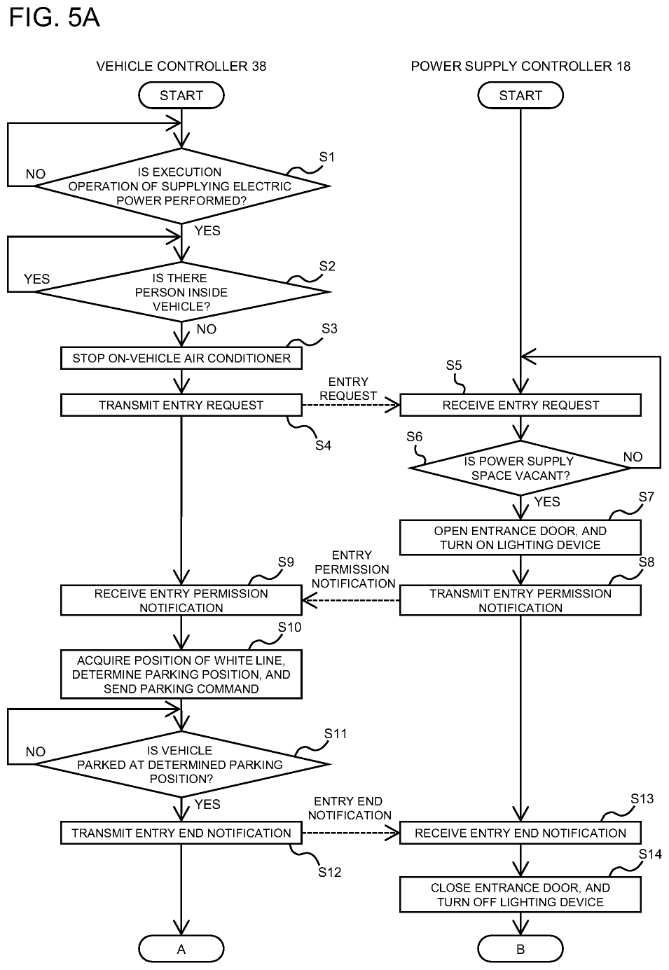

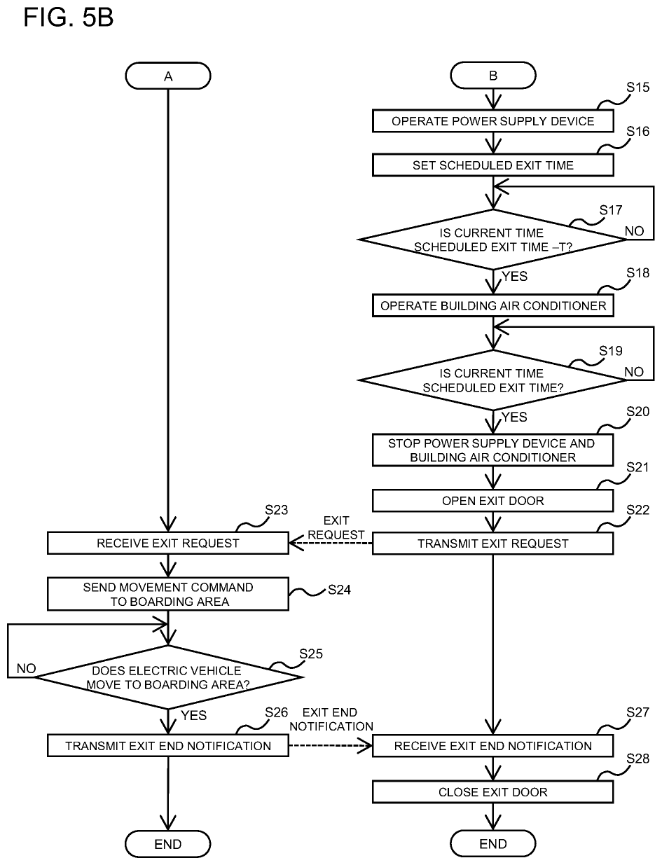

The operations executed by the power supply controller 18 of the power supplying facility 100A and the vehicle controller 38 of the electric vehicle 300A when the power supply execution operation is performed will be described with reference to the flowcharts of FIGS. 5A and 5B.

When the power supply execution operation is performed by the user, the vehicle controller 38 of the electric vehicle 300A receives the operation information. When receiving the operation information of the power supply execution operation (“YES” in step S1), the vehicle controller 38 determines whether there is a person inside the electric vehicle 300A based on the detection result obtained by the person sensor 34 (step S2). When it is determined that there is a person in the vehicle (“YES” in step S2), the vehicle controller 38 waits until the vehicle becomes unmanned. If it is determined that the vehicle is unmanned (“NO” in step S2), the vehicle controller 38 stops the on-vehicle air conditioner 35 (step S3).

Next, the vehicle controller 38 wirelessly transmits an entry request to the power supply space SP to the power supply controller 18 via the on-vehicle wireless communication device 33 (step S4). In the power supply controller 18, the vehicle entry/exit control unit 181 receives the entry request via the outdoor wireless communication device 16 (step S5) and determines whether the power supply space SP is vacant based on the detection result of a sensor (not shown) installed in the power supply space SP (step S6). To determine whether the power supply space SP is vacant, for example, a laser curtain is installed across the power supply space SP, and it can be determined that the power supply space SP is vacant when the laser beam is not blocked, and that the power supply space SP is not vacant when the laser beam is blocked.

When it is determined that the power supply space SP is vacant (“YES” in step S6), the vehicle entry/exit control unit 181 drives the entrance door drive device 14 to open the entrance door ET and turns on the lighting device 13 (step S7). The vehicle entry/exit control unit 181 wirelessly transmits an entry permission notification to the vehicle controller 38 (step S8).

The electric vehicle 300A waits in the alighting area PA until receiving the entry permission notification from the power supply controller 18. When the entry permission notification is received (step S9), the vehicle controller 38 requests the marker recognition device 37 for the position information of the white line L. When the position information of the white line L is requested, the marker recognition device 37 recognizes the position of the white line L by capturing an image of the inside of the building X through the opening of the entrance door ET and analyzing information of the image. At this time, since the lighting device 13 in the building X is lit, the white line L is illuminated by light from the lighting device 13, and an image of the white line L can be clearly captured, and the position of the white line L can be clearly recognized by analyzing information of the image. The marker recognition device 37 sends the acquired position information of the white line L to the vehicle controller 38.

When the vehicle controller 38 acquires the position information of the white line L, the vehicle controller determines the parking position of the electric vehicle 300A with respect to the white line L so as to align the power receiving device 31 with the position of the power supply device 11 of the power supply space SP on the basis of the position of the power receiving device 31 in the vehicle body. For example, it is assumed that white lines L are provided at a position that is a first predetermined distance forward, and at positions that are a second predetermined distance to the left and light, from the installation position of the power supply device 11 in the power supply space SP. It is also assumed that the power receiving device 31 of the electric vehicle 300A is installed at the center of the vehicle body in the lateral direction and at a third predetermined distance from the front end of the vehicle body. In this case, the power receiving device 31 of the electric vehicle 300A is aligned with the power supply device 11 of the power supply space SP by determining the parking position such that the center of the vehicle body of the electric vehicle 300A is aligned with a center line between the right and left white lines L and the front end of the vehicle body is positioned at a distance (the first predetermined distance—the third predetermined distance) backward from the front white line L.

When the vehicle controller 38 determines the parking position of the electric vehicle 300A, the vehicle controller 38 sends a parking command to the automatic parking mechanism 36 to park the vehicle in accordance with the determined position (step S10). Based on the received parking command, the automatic parking mechanism 36 makes the electric vehicle 300A enter through the entrance opening of the building X and park at the parking position with the white line L as a target by means of automatic driving.

When the electric vehicle 300A is parked at the parking position (“YES” in step S11), it is possible to perform wireless power supply with high efficiency since the power receiving device 31 faces the power supply device 11. When the electric vehicle 300A is parked at the parking position, the vehicle controller 38 transmits an entry end notification to the power supply controller 18 (step S12). In the power supply controller 18, when the entry end notification is received (step S13), the vehicle entry/exit control unit 181 drives the entrance door drive device 14 to close the entrance door ET and turns off the lighting device 13 (step S14).

Next, the power transmission control unit 182 of the power supply controller 18 instructs the power supply device 11 to start wireless power supply (step S15). The power supply device 11 starts wireless power supply to the electric vehicle 300A based on the received instruction. The electric power transmitted from the power supply device 11 is received by the power receiving device 31 of the electric vehicle 300A and charged to the battery 32.

Here, when the on-vehicle air conditioner 35 is operated to bring the inside of the electric vehicle 300A to a comfortable temperature while charging the battery 32, some of the electric power received by the power receiving device 31 is consumed by the on-vehicle air conditioner 35, and the electric power used for charging the battery 32 decreases. Therefore, the battery 32 is charged more slowly than when the on-vehicle air conditioner 35 is not operated, and the time until the battery 32 reaches full charge becomes longer. In the present embodiment, since the on-vehicle air conditioner 35 is stopped, all the electric power received by the power receiving device 31 is sent to the battery 32, and the battery 32 is charged faster, and thus the time until the battery 32 is fully charged is shortened.

When electric power transmission to the electric vehicle 300A by the power supply device 11 is started, the power transmission control unit 182 sets a scheduled exit time at which the electric vehicle 300A finishes charging and exits from the building X (step S16). The scheduled exit time of the electric vehicle 300A is calculated by the current time+required power supply time (U). The required power supply time (U) is, for example, an estimate of the time required to charge the battery 32 to a full charge (i.e., a charge rate of 100%) or to a predetermined charge rate (e.g., 80%), when power supply to the battery 32 from the power supply device 11 is started. Alternatively, if the electric vehicle 300A is reserved to be used at a predetermined time (reserved use time) before the time indicated by the current time+the required power supply time (U), the reserved use time may be used as the scheduled exit time.

Here, an air conditioning set temperature (D) and a building air conditioning time period (T) of the building air conditioner 12 are preset in the building air conditioning control unit 183. These values are set so that the air in the building X, which is air-conditioned by the operation of the building air conditioner 12, circulates in the interior of the electric vehicle 300A through a ventilation port or the like of the electric vehicle 300A, thereby making the temperature in the interior of the electric vehicle 300A comfortable for a person. That is, when the building air conditioner 12 is operated for the building air conditioning time period (T) at the air conditioning set temperature (D), the inside of the electric vehicle 300A becomes a temperature at which a person feels comfortable. When the building air conditioning control unit 183 recognizes that the current time has arrived before the set scheduled exit time of the electric vehicle 300A by a length of time corresponding to the predetermined time period (T) (“YES” in step S17), the building air conditioner 12 starts the air conditioning operation at the air conditioning set temperature (D) (step S18).

The air conditioning set temperature (D) may be set higher than a comfortable temperature for a person when heating is performed in winter, and lower when cooling is performed in summer, in consideration of the fact that there is a delay in heat transfer from the outside of the electric vehicle to the inside of the electric vehicle due to the circulation of air and thus the temperatures in the inside and outside of the electric vehicle do not always match, and that the temperature in the inside of the electric vehicle changes due to the influence of the outside air temperature when the electric vehicle exits from the power supply space SP. The building air conditioning time period (T) may be set to be different depending on the outside air temperature.

If the reserved use time of the electric vehicle 300A is used as the scheduled exit time and changed to a later time by the user during power supply to the battery 32, the scheduled exit time is also changed to a later time. If the building air conditioner 12 is not operating at the time of the change, the start time of the operation of the building air conditioner 12 is also changed to a later time in accordance with the changed scheduled exit time. This control prevents the building air conditioner 12 from operating unnecessarily.

The building air conditioning control unit 183 operates the building air conditioner 12 immediately upon the start of power supply if the remaining time up to the scheduled exit time is already equal to or less than the building air conditioning time period (T) when the power transmission control unit 182 sets the scheduled exit time. Alternatively, when the power transmission control unit 182 sets the scheduled exit time, if the required power supply time (U) is shorter than the building air conditioning time period (T), the time indicated by the current time+the building air conditioning time period (T) may be set as the scheduled exit time in order to secure time for making the temperature in the electric vehicle 300A comfortable.

When the building air conditioner 12 operates at the air conditioning set temperature (D) for the building air conditioning time period (T), the inside of the building X is air-conditioned, and air circulates through the ventilation port or the like of the electric vehicle 300A, and thus the inside temperature of the electric vehicle 300A becomes a temperature at which a person feels comfortable. When the current time reaches the set scheduled exit time (“YES” in step S19), the power transmission control unit 182 stops the power supply device 11, and the building air conditioning control unit 183 stops the building air conditioner 12 (step S20). When the battery 32 is fully charged before the scheduled exit time, the power transmission control unit 182 stops the power supply device 11 at that time.

When the current time reaches the set scheduled exit time, the vehicle entry/exit control unit 181 drives the exit door drive device 15 to open the exit door EX (step S21). When the exit door EX is opened, the vehicle entry/exit control unit 181 wirelessly transmits an exit request to the vehicle controller 38 (step S22).

When the electric vehicle 300A receives the exit request (step S23), the vehicle controller 38 sends a movement command to move to the boarding area QA in front of the exit door EX outside the building X, to the automatic parking mechanism 36 (step S24). Based on the received movement command, the automatic parking mechanism 36 makes the electric vehicle 300A exit from the exit door EX to the outside of the building X and park in the boarding area QA by means of automatic driving.

At this time, if the relative position of the boarding area QA with respect to the power supply space SP is known, the electric vehicle 300A may be automatically driven using a dead reckoning technique for measuring the position and direction of the electric vehicle 300A from the rotational speed and the steering angle of the wheels. Alternatively, if the latitude and longitude of the boarding area QA are known, the electric vehicle 300A may be automatically driven by measuring its position by receiving a GPS (Global Positioning System) radio wave when the electric vehicle 300A leaves the building X.

When the electric vehicle 300A moves to the boarding area QA (“YES” in step S25), the vehicle controller 38 transmits an exit end notification to the power supply controller 18 (step S26). When the power supply controller 18 receives the exit end notification (step S27), the vehicle entry/exit control unit 181 drives the exit door drive device 15 to close the exit door EX (step S28). Then, the user gets into the electric vehicle 300A in the boarding area QA, and the on-vehicle air conditioner 35 is appropriately operated by the user to start operating.

When another electric vehicle 300A stops at the alighting area PA and the user performs the power supply execution operation, the power supply controller 18 performs the operation described above again so that the other electric vehicle 300A can receive electric power.

According to the first embodiment described above, when electric power is supplied to the electric vehicle, the air conditioning in the building where the electric vehicle is parked is operated only for a certain period of time before the power supply ends, and thus power supply processing can be performed while adjusting the temperature in the vehicle. Thus, after the power supply is completed, the user can ride in the electric vehicle in a state where the temperature in the vehicle is comfortable for a person. Since the on-vehicle air conditioner is not operated when electric power is supplied, all the supplied electric power is used for charging the battery, and power supply processing can be performed in a short time. The above operation is performed automatically and unmanned, and the availability of the electric vehicle can be enhanced. In addition, since the air conditioning of the building is operated only for a certain period of time, electric power consumption can be reduced.

In the present embodiment, the entry of the electric vehicle into the power supply space, the power supply to the electric vehicle, the air-conditioning operation of the building, and the exit of the electric vehicle from the power supply space are all performed unmanned. Thereby, the power supply processing is not delayed by the operations of an operator, the turnover rate of the power supply processing to electric vehicles can be increased, and the charging waiting time of the user can be reduced.

Further, since a person does not get on and off an electric vehicle in the building, it is not necessary to open and close the doors of the electric vehicle in the building, and a space for opening and closing the doors is not required. Therefore, it is sufficient if the width of the inside of the building is slightly larger than the width of the electric vehicle, and it is possible to reduce electric power required for air conditioning of the building by constructing a building having a smaller volume.

In addition, since the inside of the building is unmanned, the concentration of CO₂ in the air inside the building does not rise due to people breathing. Since the electric vehicle runs without generating exhaust gas, the air in the building is not contaminated with the exhaust gas. Therefore, since fresh air suitable for human respiration is maintained in the building even when the doors of the openings are closed without performing ventilation in the building, ventilation is not required when the building is air-conditioned, and electric power required for air conditioning can be suppressed.

In the first embodiment described above, when there are a plurality of electric vehicles receiving power supply, an ID (identification) unique to the vehicle is also transmitted to the power supply controller 18 when each electric vehicle transmits the entry request. The power supply controller 18 identifies each electric vehicle by using the ID and performing wireless communication, and the power supply controller 18 can thereby perform the power supply processing for a plurality of electric vehicles.

### Second Embodiment

In the first embodiment described above, the power supplying facility 100A including one power supply space SP has been described. However, when such a power supplying facility 100A is shared and used by a large number of electric vehicles used for, for example, car sharing, the charging execution timing of a plurality of electric vehicles overlaps and a waiting time for charging may occur. If there is a waiting time for charging, the electric vehicle may not be available when the user wants to use the electric vehicle.

To prevent the occurrence of such a situation, in the present embodiment, a case where power is supplied to a plurality of electric vehicles 100B by a power supplying facility 300B including a plurality of power supply spaces will be described.

<Configuration of Power Supplying Facility According to Second Embodiment>

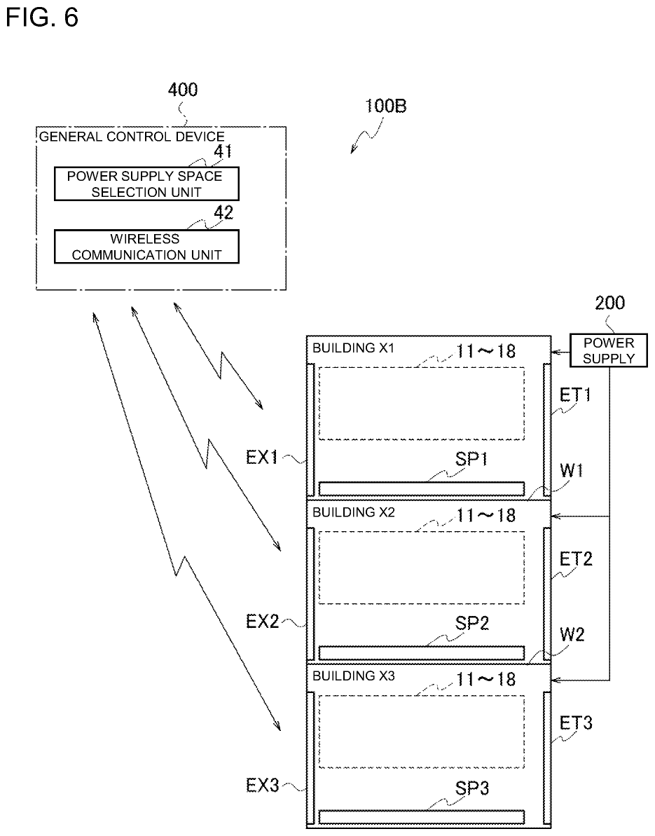

The configuration of the power supplying facility for the electric vehicle according to the present embodiment will be described with reference to FIG. 6. The power supplying facility 100B according to the present embodiment includes the devices 11 to 18 and the like installed in each of a plurality of buildings (buildings X1, X2, and X3), and a general control device 400. In the present embodiment, each of the buildings X1, X2, and X3 has the same structure as that of the building X described in the first embodiment, and as shown in FIG. 6, each of the partitions divided by walls W1 and W2 in an integral structure may constitute a building X1, X2, and X3, or each of the buildings X1, X2, and X3 may be an independent structure and may be installed separately from each other. When the buildings X1, X2, and X3 are constituted by an integrated structure, the building air conditioner 12 in the central building X2 is installed on the ceiling of the building X2 because there is no wall surface facing the external space.

The buildings X1, X2, and X3 are provided with power supply spaces SP1, SP2, and SP3, entrance doors ET1, ET2, and ET3, and exit doors EX1, EX2, and EX3, respectively. In the present embodiment, three buildings are described, but the number of buildings is not limited to this, and two or four or more buildings may be used.

In the present embodiment, the outdoor wireless communication devices 16 of the buildings X1, X2, and X3 perform wireless communication with an electric vehicle 300B positioned outside the buildings X1, X2, and X3 and to be supplied with power, and perform wireless communication with the general control device 400. The power supply controllers 18 of the buildings X1, X2, and X3 and the general control device 400 may be connected by wiring to perform wired communication.

The general control device 400 includes a power supply space selection unit 41 and a wireless communication unit 42. When receiving an entry request from the electric vehicle 300B, the power supply space selection unit 41 selects a vacant power supply space as a power supply space to be entered by the electric vehicle 300B. The wireless communication unit 42 performs wireless communication with the outdoor wireless communication device 16 of each of the buildings X1, X2, and X3, and the on-vehicle wireless communication device 33 of the electric vehicle 300B. The wireless communication unit 42 may also perform wireless communication with each of the indoor wireless communication devices 17 of the buildings X1, X2, and X3.

The configuration of the electric vehicle 300B powered by the power supplying facility 100B in the present embodiment is the same as that of the electric vehicle 300A described in the first embodiment as shown in FIG. 3, and therefore a detailed description of the parts having the same functions will be omitted. The on-vehicle wireless communication device 33 of the electric vehicle 300B performs wireless communication with the outdoor wireless communication device 16 and the indoor wireless communication device 17 of the power supplying facility 100B and performs wireless communication with the general control device 400. The vehicle controller 38 holds an ID for identifying the host vehicle. The ID is different for each vehicle and allows the host vehicle to be identified and communicated in wireless communication. As the ID, for example, a telephone number can be used when performing wireless communication using a communication network of a cellular phone.

<Operation when Electric Power is Supplied to Electric Vehicle 300B by Power Supplying Facility 100B in Second Embodiment>

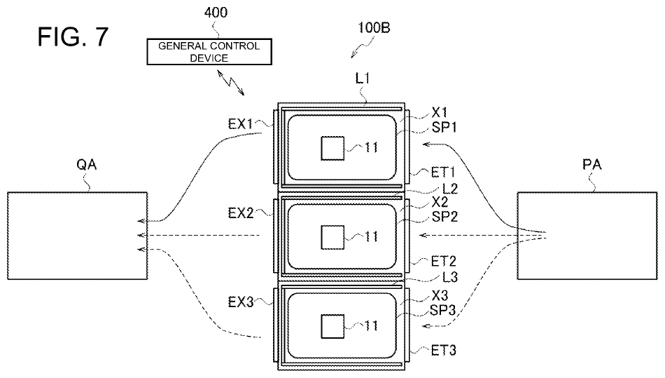

In the present embodiment, the buildings X1, X2, and X3 of the power supplying facility 100B are arranged in parallel with the alighting area PA and the boarding area QA as shown in FIG. 7. When electric power is to be supplied to the electric vehicle 300B by the power supplying facility 100B, the electric vehicle 300B stops at the alighting area PA in front of the entrance of the buildings X1 to X3, and all passengers alight and the doors of the vehicle body are closed. Then, the user performs the power supply execution operation. When the power supply execution operation is performed, a series of operations described below is started, and electric power is supplied to the electric vehicle 100B by the power supplying facility 300B. The user performs only the power supply execution operation, and the series of operations after the power supply execution operation are automatically executed without requiring a user operation.

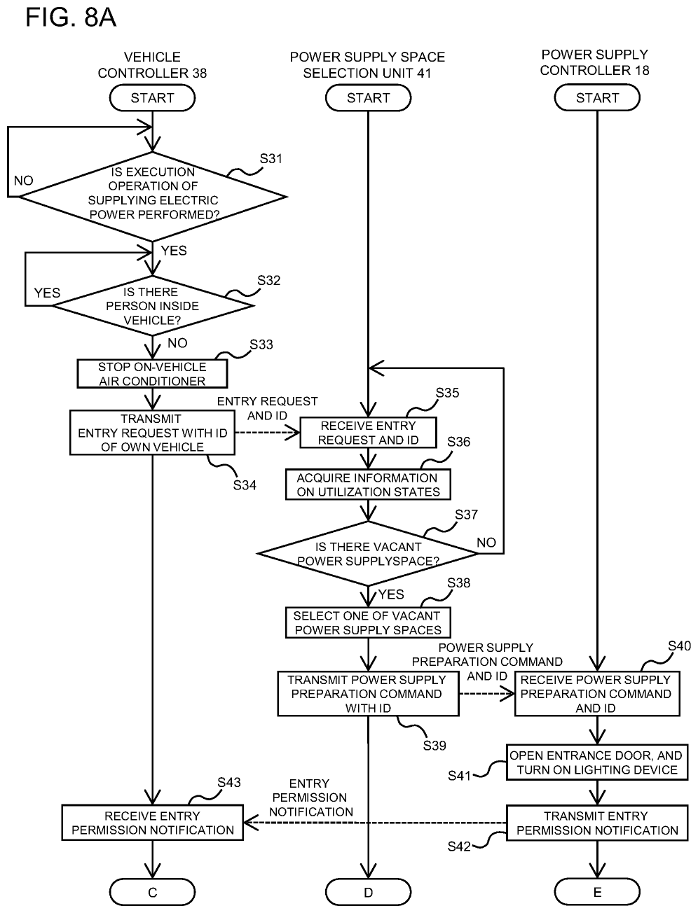

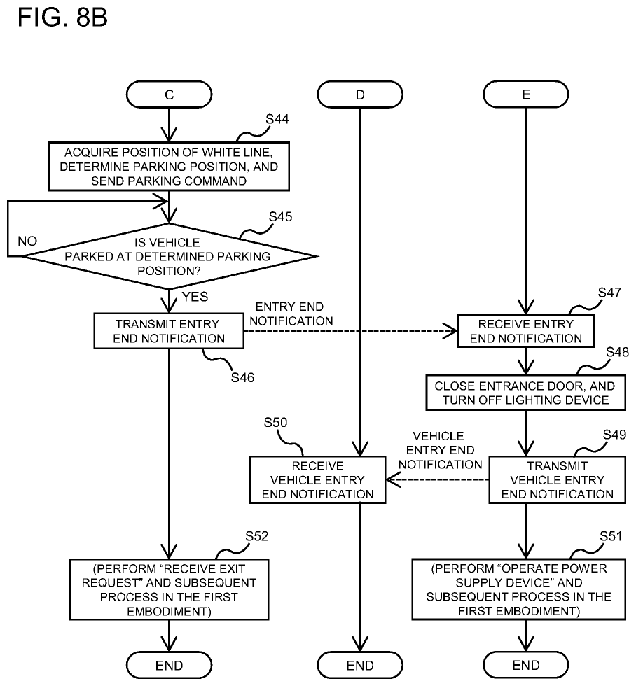

The operations executed by the power supply controller 18 of the power supplying facility 100B, the vehicle controller 38 of the electric vehicle 300B, and the power supply space selection unit 41 of the general control device 400 when the power supply execution operation is performed will be described with reference to the flowcharts of FIGS. 8A and 8B.

When the power supply execution operation is performed by the user, the vehicle controller 38 of the electric vehicle 300B receives the operation information. When receiving the operation information of the power supply execution operation (“YES” in step S31), the vehicle controller 38 determines whether there is a person inside the electric vehicle 300B based on the detection result obtained by the person sensor 34 (step S32). When it is determined that there is a person in the vehicle (“YES” in step S32), the vehicle controller 38 waits until the vehicle becomes unmanned. If it is determined that the vehicle is unmanned (“NO” in step S32), the vehicle controller 38 stops the on-vehicle air conditioner 35 (step S33). Then, the vehicle controller 38 wirelessly transmits an entry request for entering any of the power supply spaces SP to the general control device 400 together with an ID for identifying the host vehicle (step S34).

In the general control device 400, the power supply space selection unit 41 receives the entry request and the ID via the wireless communication unit 42 (step S35). Upon receiving the entry request, the power supply space selection unit 41 communicates with the power supply controllers 18 of the buildings X1, X2, and X3 to acquire information on utilization states (whether the power supply spaces SP1, SP2, and SP3 are vacant) (step S36). If there is a vacant power supply space based on the acquired information (“YES” in step S37), one of the vacant power supply spaces is selected as a power supply space to be entered by the electric vehicle 300B (step S38). Here, it is assumed that the power supply space selection unit 41 selects the power supply space SP1 as the power supply space to be entered by the electric vehicle 300B.

Next, the power supply space selection unit 41 transmits a power supply preparation command together with the ID received in step S35 to the power supply controller 18 of the building X1 corresponding to the selected power supply space SP1 (step S39). Here, the electric vehicle 300B having the ID becomes a target for being supplied with electric power in the building X1. In the power supply controller 18 of the building X1, when receiving the power supply preparation command (step S40), the vehicle entry/exit control unit 181 drives the entrance door drive device 14 to open the entrance door ET1 and illuminates the lighting device 13 (step S41). The vehicle entry/exit control unit 181 wirelessly transmits an entry permission notification to the vehicle controller 38 of the electric vehicle 300B having the ID received in step S39 (step S42).

When the vehicle controller 38 receives the entry permission notification (step S43), the vehicle controller 38 requests the marker recognition device 37 for the position information of the white line. When the position information of the white line is requested, the marker recognition device 37 recognizes the position of the white line by capturing an image of the inside of the building X1 through the opening of the entrance door ET1 and analyzing information of the image.

Here, the general control device 400 does not accept the entry request from another electric vehicle until the processing for the entry request received from the electric vehicle 300B is completed, that is, until the electric vehicle 300B enters any of the power supply spaces and parks. Therefore, at this time, the power supply space in which the entrance door is opened and illuminated by the lighting device 13 is limited to the power supply space SP1. When the electric vehicle 300B automatically enters the building X1, the entrance doors ET2 and ET3 of the other buildings X2 and X3 are closed, and only the white line L1 of the power supply space SP1 can be seen, and thus the marker recognition device 37 can recognize the position of the white line L1 and does not recognize the white lines L2 and L3 in the other buildings X2 and X3. That is, in step S44, the vehicle controller 38 requests the marker recognition device 37 to provide positional information of white lines that does not specify L1, L2, and L3, but since only L1 is visible as a white line, the marker recognition unit 37 can recognize the position of the white line L1 by extracting the white line from the image. The marker recognition device 37 sends the acquired position information of the white line L1 to the vehicle controller 38.

When the vehicle controller 38 acquires the position information of the white line L1, the vehicle controller determines the parking position of the electric vehicle 300B with respect to the white line L1 so as to align the power receiving device 31 with the position of the power supply device 11 of the power supply space SP1 based on the position of the power receiving device 31 in the vehicle body. To perform this alignment without identifying the buildings X1, X2, and X3, it is assumed that the first predetermined distance described in the description of the first embodiment is the same for the buildings X1, X2, and X3, and the second predetermined distance is also the same for the buildings X1, X2, and X3. The third predetermined distance may be different for each electric vehicle 300B. For example, the third predetermined distance may be stored in the vehicle controller 38 of the electric vehicle.

When the vehicle controller 38 determines the parking position of the electric vehicle 300B, the vehicle controller 38 sends a parking command to the automatic parking mechanism 36 to park the vehicle in accordance with the position (step S44). Based on the received parking command, the automatic parking mechanism 36 makes the electric vehicle 300B enter the building X1 and park at the parking position with the white line L as a target by means of automatic driving.

When the electric vehicle 300B is parked at the parking position (“YES” in step S45), the vehicle controller 38 transmits an entry end notification to the power supply controller 18 (step S46). In the power supply controller 18, when the entry end notification is received (step S47), the vehicle entry/exit control unit 181 drives the entrance door drive device 14 to close the entrance door ET1 and turns off the lighting device 13 (step S48). Further, the vehicle entry/exit control unit 181 transmits a vehicle entry end notification to the general control device 400 (step S49). In the general control device 400, the power supply space selection unit 41 receives the vehicle entry end notification (step S50).

Thereafter, the power supply processing in the power supply space SP1 and the processing to exit from the building X1 to be executed for the electric vehicle 300B are the same as the power supply processing and the processing to exit from the building X to be executed for the electric vehicle 300A described in the first embodiment, and therefore a detailed description thereof is omitted (steps S51 and S52).

In the power supply processing according to the present embodiment, the scheduled exit time of the electric vehicle is reset for each power supply space and for each new entry of the electric vehicle. The building air conditioning time period (T) used for controlling the building air conditioner 12 may be different for each corresponding power supply space or may be the same for all.

In addition, since the power supply processing according to the present embodiment is executed independently for each power supply space, the progress of the power supply process shown in FIGS. 8A and 8B may differ for each building (each power supply space).

When another electric vehicle 300B stops at the alighting area PA after the power supply space selection unit 41 finishes the step S50 and the user performs the power supply execution operation, the power supply space selection unit 41 performs the operation described above again so that the other electric vehicle 300B can receive power supply. Unlike the first embodiment, since there is a plurality of power supply spaces, the second electric vehicle 300B can be parked in another power supply space and receive power supply even when the first electric vehicle 300B receives power supply in the power supply space.

According to the second embodiment described above, the second embodiment has the same effect as the first embodiment, electric power can be supplied to a plurality of electric vehicles simultaneously, the battery of an electric vehicle can be charged quickly, and the availability of an electric vehicle can be enhanced.

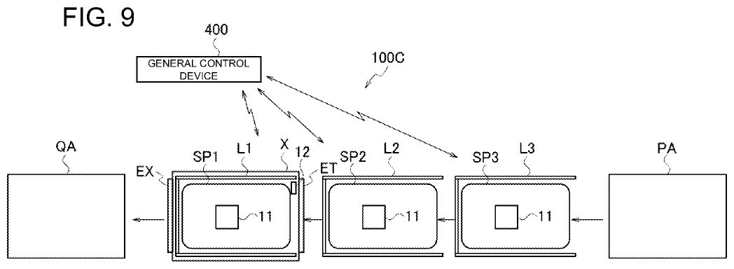

In the second embodiment described above, the power supplying facility 100B in which a plurality of power supply spaces SP1, SP2, and SP3 are arranged in parallel with respect to the alighting area PA and the boarding area QA has been described. However, the present disclosure is not limited to this, and the plurality of power supply spaces SP1, SP2, and SP3 may be arranged one behind another in series with respect to the alighting area PA and the boarding area QA, as in the power supply facility 100C shown in FIG. 9.

In this configuration, a plurality of power supply devices 11 are provided in the plurality of power supply spaces SP1, SP2, and SP3, respectively, and electric vehicles can park in the plurality of power supply spaces in line one behind another from the head side to the tail side of the plurality of power supply spaces. Then, the general control device 400 makes two or more electric vehicles 300 park in line one behind another from the power supply space SP1 on the head side. After the power supply to one electric vehicle 300 parked in the leading power supply space SP1 is stopped, the general control device 400 moves the one electric vehicle 300 to the outside of the power supply space SP1 and moves the other electric vehicle 300 positioned behind the one electric vehicle 300 to the leading power supply space SP1.

In the power supplying facility 100C, among the plurality of electric vehicles 300 being charged, the electric vehicle 300 being charged by parking in the leading power supply space SP1 is moved first to the boarding area QA for use. Therefore, it is sufficient for only the leading power supply space SP1 among the plurality of power supply spaces SP1, SP2, and SP3 to be installed in an air-conditioned space.

Therefore, the leading power supply space SP1 is installed in the building X, and the building air conditioner 12 which is communicatively connected to the power supply device 11 installed in the power supply space SP1 and conditions air inside of the building X based on the operation state of the power supply device 11 is installed in the building X. The power supply spaces SP2 and SP3 may be installed outdoors instead of being installed in the building. Alternatively, the power supply spaces SP2 and SP3 may be installed in a building without a building air conditioner.

When the power supplying facility 100C is configured in the above-mentioned manner, the operation rate of the building air conditioner 12 installed corresponding to the leading power supply space SP1 is high. For example, as shown in FIG. 9, when the leading power supply space SP1 is arranged in series with the other two power supply spaces SP2 and SP3, the building air conditioner 12 operates three times as often as when the three power supply spaces SP1, SP2, and SP3 are arranged in parallel. Therefore, the building air conditioner 12 may be made to operate all the time.

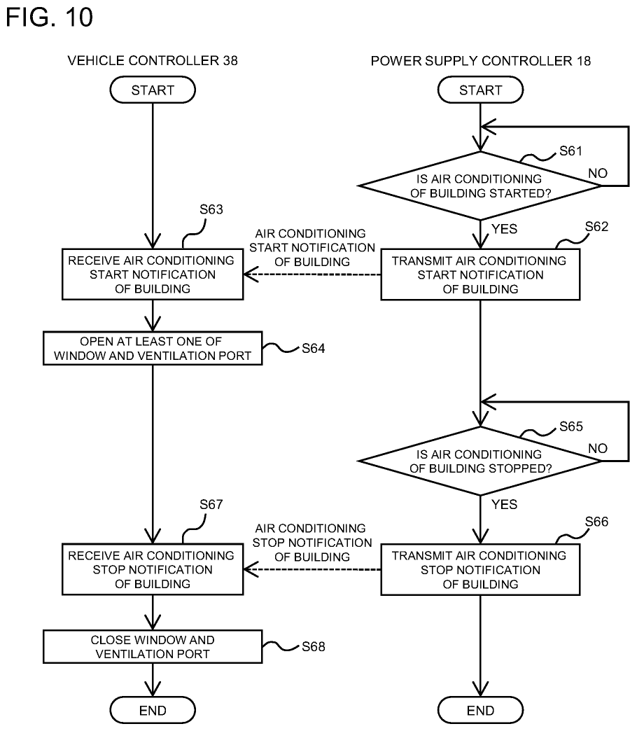

With reference to the flowchart of FIG. 10, a description will be given regarding an operation that can be executed when the opening and closing of the windows and ventilation port of the electric vehicle 300 (the electric vehicle 300A or the electric vehicle 300B) can be automatically performed by means of a command from the vehicle controller 38, in the first and second embodiments described above.

When air conditioning of the building X is started (“YES” in step S61), the building air conditioning control unit 183 of the power supply controller 18 transmits an air conditioning start notification of the building X to the vehicle controller 38 (step S62). When the vehicle controller 38 receives the air conditioning start notification of the building X (step S63), at least one of the windows (power windows) and the ventilation port is automatically opened (step S64). When the air conditioning of the building X is stopped (“YES” in step S65), the building air conditioning control unit 183 transmits an air conditioning stop notification of the building X to the vehicle controller 38 (step S66). When the vehicle controller 38 receives the air conditioning stop notification of the building X (step S67), the window and the ventilation port are automatically closed (step S68).

Thus, by automatically opening at least one of the windows and the ventilation port of the electric vehicle 300 during the operation of the building air conditioner 12, the inside and outside of the electric vehicle 300 are better ventilated during the operation of the building air conditioner 300, and the time at which the temperature inside the electric vehicle reaches a temperature at which a person feels comfortable is shortened. Thus, the operation time of the building air conditioner 12 can be shortened by shortening the building air conditioning time period (T), and the electric power consumption can be reduced. When the building air conditioner 12 is stopped and the electric vehicle 300 exits from the power supply space SP, the windows and ventilation port of the electric vehicle 300 are automatically closed, and thus the air inside the electric vehicle is hardly affected by the temperature of the outside air, and the temperature inside the electric vehicle 300 is kept in a comfortable state. When only one of the windows and the ventilation port can be opened and closed automatically, only one of the windows and the ventilation port may be opened and closed automatically by the flow described with reference to FIG. 10.

A fan of the on-vehicle air conditioner may be operated in an outside air introduction mode during the air conditioning operation of the building X. Though some of the supplied electric power is consumed by operating the fan of the on-vehicle air conditioner, the electric power consumption of the operation of the fan is notably less than that of the air conditioner, and thus the charging time of the battery is not greatly affected.

Further, in the case where at least one of the windows and the ventilation port of the electric vehicle 300 is configured to be opened and closed automatically as described above, an ozone generator (not shown) may be installed in the building X, and ozone fumigation in the electric vehicle 300 may also be performed during charging processing. For example, before operating the building air conditioner, ozone gas is generated from the ozone generator and at least one of the windows and the ventilation port of the electric vehicle 300 is opened to circulate the ozone gas in the electric vehicle 300. Here, the timing of generating the ozone gas and the concentration of the ozone gas are set so that the ozone is decomposed by the scheduled exit time of the electric vehicle 300. As described above, sterilization treatment in the electric vehicle 300 can be performed by means of the ozone gas while the electric vehicle 300 is charged.

In the first and second embodiments described above, the white line L is provided as a marker in the power supply space, and the parking position of the electric vehicle 300 is determined by recognizing the position of the white line L from the information of the image captured by the imaging apparatus mounted on the electric vehicle 300. However, the present disclosure is not limited to this method, and a retroreflector may be provided as a marker in the power supply space, and a LIDER as the marker recognition device 37 may be mounted on the electric vehicle 300. In this case, the LIDER determines the parking position of the electric vehicle 300 by measuring the distance and orientation to the installed retroreflector and recognizing the position of the power supply space. In this method, since the LIDER can measure the distance to the retroreflector by emitting a laser beam for distance measurement by itself, illumination by the lighting device 13 is not required.

Further, as another method for determining the parking position of the electric vehicle 300, UWB (ultra-wide band; ultra-wideband wireless) technology can be used. In this method, a tag for transmitting a UWB pulse is installed as a marker in a power supply space, and a UWB sensor as a marker recognition device 37 is mounted on the electric vehicle 300. The UWB sensor receives the pulse transmitted from the tag and recognizes the position of the power supply space to determine the parking position of the electric vehicle 300. Since the UWB sensor measures the position of the tag by receiving the pulse (radio wave), illumination by the lighting device 13 is also unnecessary in this method. Since the entrance door ET is in an open state during measurement, the UWB pulse emitted by the tag in the power supply space is received by the UWB sensor through the opening of the entrance door ET without interference of radio waves by the entrance door ET, and the position of the power supply space can be recognized.

In the first and second embodiments described above, the power receiving device 31 is installed on the lower surface of the electric vehicle 300, and the power supply device 11 is installed on the floor surface of the building X. However, the present disclosure is not limited to this. It is sufficient for the power receiving device 31 and the power supply device 11 to be installed so as to face each other and be close to each other to enable wireless power supply when the electric vehicle 300 is parked properly in the power supply space SP. For example, the power receiving device 31 may be installed on a side surface of the electric vehicle 300, and the power supply device 11 may be installed on a wall surface of the building X.

In the first and second embodiments described above, the case where the alighting area and the boarding area are on opposite sides of the power supply space SP has been described. However, the present disclosure is not limited to this, and the boarding area and the alighting area may be on the same side with respect to the power supply space SP, and one building opening may serve as an entrance and an exit for the electric vehicle 300.

Further, in the first and second embodiments described above, there has been described a case where there is one alighting area and one boarding area in each of the power supplying facilities 100A and 100B, but the present disclosure is not limited to this, and there may be a plurality of alighting areas and a plurality of boarding areas. For example, in a power supplying facility installed in a large condominium or the like having a plurality of entrances, an alighting area and a boarding area may be provided for each entrance, and a resident may use the power supplying facility by getting on and off at the alighting area and the boarding area at the entrance close to the resident's living quarters.

In the description of the first embodiment, the alighting area PA and the boarding area QA are shown as solid lines in FIG. 4, but these are conceptually indicative of the areas, and solid lines may or may not be drawn on the road surface. For example, the area may be painted in a color that is distinct from the road surface to visually indicate the area, or a location that cannot be visually identified may be defined as the alighting area PA or the boarding area QA. The same applies to the alighting area PA and the boarding area QA in the second embodiment.

The positional relationship among the alighting area PA, the boarding area QA, and the building X in the first embodiment is not limited to the positional relationship illustrated in FIG. 4. It is sufficient for the positional relationship to be arranged such that the on-vehicle wireless communication device 33 can perform wireless communication with the outdoor wireless communication device 16 or the indoor wireless communication device 17 of the power supplying facility 100A, the electric vehicle 300A can automatically park by traveling unmanned from the alighting area PA to the building X by means of the automatic parking mechanism 36, and the electric vehicle 300A can automatically park by traveling unmanned from the building X to the boarding area QA by means of the automatic parking mechanism 36. For example, the distance between the alighting area PA and the building X may be closer or farther than the distance illustrated in FIG. 4. The alighting area PA and the building X are illustrated as being in the same direction in FIG. 4. However, the directions can be set to be different. The distance between the boarding area QA and the building X may be closer or farther than the distance illustrated in FIG. 4. The boarding area QA and the building X are illustrated as being in the same direction in FIG. 4. However, the directions can be set to be different. The positional relationship among the alighting area PA, the boarding area QA, and the buildings X1, X2, and X3 in the second embodiment is not limited to the positional relationship illustrated in FIG. 7. The directions of the building X1, the building X2 and the building X3 may be different from each other, or the plurality of the buildings may not be located in a straight line.

In the first and second embodiments described above, the walls and ceilings of the building X may include a material for shielding electromagnetic fields (for example, a magnetic material, a non-magnetic electrically conductive material, or a composite material thereof), or may include a material for shielding electromagnetic fields. By using such a material, the electromagnetic field generated by the wireless power supply is prevented from propagating from the inside of the building X to the outside.

In the first and second embodiments described above, the building air conditioner is operated only for a certain period of time before power supply to the electric vehicle ends. However, the present disclosure is not limited to this. For example, in a case where a power supplying facility is frequently used, or in a cold climate where the building air conditioner must be operated for a long time before the temperature in the building reaches a set temperature, the average electric power consumption of the building air conditioner may be lower if the building air conditioner is operated at all times than if the air conditioner is repeatedly operated and stopped at each time of power supply processing. In such a case, electric power consumption may be reduced by making the building air conditioner operate all the time.

Further, the electric vehicle charged in the first and second embodiments may be a hybrid vehicle or a fuel cell vehicle in which an engine and a fuel cell are mounted together with a battery.

Although some embodiments have been described, it is possible to change or modify the embodiments based on the content disclosed above. All the components of the above embodiment and all the features described in the claims may be individually extracted and combined as long as they do not contradict each other.

According to the present disclosure, it is possible to contribute to Goal 11 of the United Nations-led Sustainable Development Goals (SDGs): “Make cities and human settlements inclusive, safe, resilient and sustainable.”

What is claimed is:

1. A power supplying facility for an electric vehicle, the power supplying facility comprising:
a power supply device
installed in a building that has a power supply space for supplying power to the electric vehicle having a battery, and
supplying power wirelessly to the battery of the electric vehicle parked in the power supply space by means of an automatic parking function, and
a building air conditioner
communicatively connected to the power supply device, and
conditioning air inside of the building based on an operating state of the power supply device.

2. The power supplying facility according to claim 1, wherein
when the electric vehicle is parked in the power supply space and supplied with electric power by the power supply device, the building air conditioner starts conditioning air at a time that is a predetermined time period before a scheduled exit time at which the power supply device stops supplying electric power and the electric vehicle exits from the building.

3. The power supplying facility according to claim 1, wherein
the electric vehicle is provided with a sensor configured to detect a person in the electric vehicle, and
when electric power is supplied to the electric vehicle, upon it being determined that inside of the electric vehicle is unmanned based on a detection result obtained by the sensor, the electric vehicle is parked in the power supply space by means of the automatic parking function.

4. The power supplying facility according to claim 1, wherein
the building is further provided with a marker installed in the power supply space,
the electric vehicle is provided with a marker recognition device for recognizing the marker, and
when electric power is supplied to the electric vehicle, the marker recognition device recognizes a position of the marker, and the electric vehicle is parked in the power supply space by means of the automatic parking function based on the position of the marker.

5. The power supplying facility according to claim 1, wherein
the building further includes
an opening having a size capable of allowing the electric vehicle to pass through, and
an automatic opening/closing door configured to automatically open/close the opening, which opens the opening if the power supply space is vacant when a request to enter the building is received from the electric vehicle by wireless communication, and closes the opening when it is detected that the electric vehicle has entered the building and parked in the power supply space, and
when electric power is supplied to the electric vehicle, the electric vehicle transmits an entry request for entering the building by wireless communication, and enters the building from the opening opened by transmission of the entry request and parks in the power supply space by means of the automatic parking function.

6. The power supplying facility according to claim 1, further comprising:
a plurality of buildings in which the power supply space, the power supply device, and the building air conditioner are installed, and
a general control device, wherein
when electric power is supplied to the electric vehicle, the electric vehicle transmits an entry request for entering one of the plurality of buildings, and enters the power supply space selected by transmission of the entry request and parks in the selected power supply space by means of the automatic parking function, and
the general control device selects a vacant power supply space as a power supply space to be entered by the electric vehicle upon receiving the entry request from the electric vehicle.

7. The power supplying facility according to claim 6, wherein
each of the buildings includes
an opening having a size capable of allowing the electric vehicle to pass through, and
an automatic opening/closing door configured to automatically open/close the opening, which opens the opening when the power supply space corresponding to the opening is selected by the general controller as a space to be entered by the electric vehicle, and closes the opening when it is detected that the electric vehicle has entered the building and parked in the power supply space, and
when electric power is supplied to the electric vehicle, the electric vehicle transmits the entry request, and enters the building from the opening opened by transmission of the entry request and parks in the power supply space by means of the automatic parking function.

8. A power supplying facility for an electric vehicle, the power supplying facility comprising:
a plurality of power supply devices
provided in a plurality of power supply spaces, respectively, in which electric vehicles are to park in line one behind another from a head side to a tail side of the plurality of power supply spaces, and
each supplying power wirelessly to a battery of an electric vehicle parked in a corresponding power supply space of the plurality of power supply spaces by means of an automatic parking function, and
a general control device controlling
parking of two or more of the electric vehicles in line one behind another from a power supply space on the head side of the plurality of power supply spaces,
moving of one electric vehicle parked in the power supply space on the head side out of the power supply space after stopping power supply to the one electric vehicle parked in the power supply space on the head side, and
moving of another electric vehicle positioned behind the one electric vehicle to the power supply space on the head side, wherein
the power supply space on the head side is installed in a building,
a building air conditioner is installed in the building, and
the building air conditioner is
communicatively connected to the power supply device installed in the power supply space on the head side, and
configured to condition air inside of the building based on an operating state of the power supply device installed in the power supply space on the head side.

9. The power supplying facility according claim 1, wherein
the electric vehicle is provided with at least one of a window or a ventilation port, each of which is configured to be opened and closed automatically,
the at least one of the window or the ventilation port is opened when the building air conditioner starts conditioning air, and
the at least one of the window or the ventilation port is closed when the building air conditioner stops conditioning air.

10. A power supplying method for an electric vehicle using a power supplying facility, wherein
the power supplying facility is configured by
installing a power supply device in a building having a power supply space for supplying power to the electric vehicle having a battery, and
communicatively connecting a building air conditioner to the power supply device,
the power supplying method comprising:
supplying power wirelessly by means of the power supply device to the battery of the electric vehicle parked in the power supply space by means of an automatic parking function, and
conditioning air inside of the building by means of the building air conditioner based on an operating state of the power supply device.
